(19) United States
(12) Patent Application Publication
(10) Pub. No.: US 2013/0074562 A1
(43) Pub. Date: Mar. 28, 2013

(54) ROLLING MILL LAYING HEAD PIPE HAVING MODULAR CONSTRUCTION

(71) Applicant: Keith Fiorucci, Sturbridge, MA (US)

(72) Inventor: Keith Fiorucci, Sturbridge, MA (US)

(73) Assignee: SIEMENS INDUSTRY, INC., Alpharetta, GA (US)

(21) Appl. No.: 13/611,200

(22) Filed: Sep. 12, 2012

Related U.S. Application Data
(60) Provisional application No. 61/539,014, filed on Sep. 26, 2011.
(60) Provisional application No. 61/539,062, filed on Sep. 26, 2011.
(60) Provisional application No. 61/539,069, filed on Sep. 26, 2011.
(60) Provisional application No. 61/540,590, filed on Sep. 29, 2011.
(60) Provisional application No. 61/540,602, filed on Sep. 29, 2011.
(60) Provisional application No. 61/540,609, filed on Sep. 29, 2011.
(60) Provisional application No. 61/540,617, filed on Sep. 29, 2011.
(60) Provisional application No. 61/540,798, filed on Sep. 29, 2011.

(51) Int. Cl. B21C 47/14; B23P 6/00; B21C 47/34

(52) U.S. Cl. 72/66; 72/428; 29/402.08

(57) ABSTRACT

A rolling mill coil-forming apparatus includes a rotating quill that supports an elongated path hollow structure, such as a laying head pipe, for receiving elongated material after it has been rolled. A portion or the entire elongated structure is formed from modular, selectively replaceable components. The fabricated modular structures facilitate formation of zones within the component, such as including by way of example wear-resistant zones, material transport guide structures and friction reducing zones.

### CROSS-REFERENCE TO RELATED APPLICATIONS

This application claims priority under 35 U.S.C. §119(e) to co-pending U.S. Provisional Application Ser. Nos. 61/539,014, 61/539,062, and 61/539,069, filed 26 Sep. 2011; and U.S. Provisional Application Ser. Nos. 61/540,590; 61/540,602; 61/540,609; 61/540,617; and 61/540,798, filed 29 Sep. 2011, all of which are entirely incorporated herein by reference as if fully set forth below.

### BACKGROUND

1. Field

Embodiments of the present invention relate to rolling mill coil-forming apparatuses, often referred to as laying heads, and more particularly to replaceable laying head pathways, such as laying head pipes, in laying heads.

2. Description of the Prior Art

Rolling mill coil-forming laying head apparatuses form moving rolled elongated material into a series of helical continuous loop rings. Those rings may be further processed downstream by bundling them into coils of the helical turns. Known laying heads are described generally in U.S. Pat. Nos. 5,312,065; 6,769,641; and 7,011,264, the entire contents of all of which are hereby incorporated by reference as if fully contained herein.

As described in these patents, rolling mill laying head systems comprise a quill, pipe support and a laying head pipe. The quill and pipe support are adapted to rotate the laying head pipe such that it can receive elongated material into its entry end. The laying head pipe has a curved intermediate portion that is surrounded by the quill's flared section and an end portion that projects radially outwardly from and generally tangential to the quill's rotational axis. In combination, the rotating quill and the laying head conforms the rolled material into a helical curved shape. The laying head pipe may be replaced with one of a different profile and/or diameter in order to reconfigure the laying head to accommodate different dimensioned rolled material or to replace worn pipes.

Further helical profiling of the rolled material is accomplished in a rotating helical guide that includes troughs for receiving the rolled material about its outer circumference. The helical guide described in U.S. Pat. No. 6,769,641 is of segmented, sector-shaped, modular rim construction with the circumferential troughs formed within the rim sectors.

A generally annular ring or shroud, also commonly referred to as an end ring or guide ring, has a guide surface that circumscribes the laying head pipe discharge end and helical guide, so that the elongated material is confined radially as it is discharged in now fully coiled configuration to a conveyor for subsequent bundling and other processing. A pivoting tripper mechanism, including one or more tripper paddles, may be positioned at approximately the six o'clock or bottom position of the end ring/shroud distal the quill. Varying the pivot attack angle of the tripper mechanism relative to the ring/shroud inner diameter surface is useful to control elongated material coiling, for example to compensate for varying elongated material plasticity thickness, composition, rolling speed and cross sectional structure.

Laying Head Pipe Design and Operational Constraints

As previously noted the hollow laying head pipe in combination with the rotating quill and pipe support, conform the rolled material into a helical curved shape. Typically, the laying head pipe is formed from a continuous length of symmetrical steel pipe or steel tubing that is bent in a forming jig by application of external heat and mechanical force to conform to the desired generally helical profile. Steel pipe or tubing is generally chosen for construction of laying head pipes for relative ease of workability into the desired final generally helical shape and relatively low material purchase cost. But commercial steel pipe or tubing have relatively low hardness: an undesirable limiting factor for rolling mill operation, productivity and maintenance.

Elongated material that is advancing at speeds up to approximately 500 feet/second (150 m/sec) is received in the laying head system intake end and discharged in a series of continuous coil loops at the discharge end. At such speeds, the hot rolled products exert a punishing effect on the laying head pipes, causing internal pipe surfaces to undergo rapid localized frictional wear and premature failure. Also, as the laying head pipes wear, their ability to deliver a stable ring pattern to the looped coil receiving conveyor at the discharge end of the laying head deteriorates. Unstable ring patterns disturb cooling uniformity and also contribute to coiling mishaps commonly referred to as “cobbling.”

For a number of years, it has been well accepted that laying head pipes with reduced bore sizes provide a number of significant advantages. By radially constricting the hot rolled products within a smaller space, guidance is improved and the ring pattern delivered to the cooling conveyor is more consistent, making it possible to roll at higher speeds. Unfortunately, however, these advantages have been offset to a large extent by significantly accelerated pipe wear due to the higher speed of the product. Also, the reduced bore size pipe can only be used with small diameter products, so it must be replaced by a larger bore size pipe for coiling of larger diameter products.

Frequent and costly mill shutdowns and preventive maintenance are required to replace prematurely worn laying head pipes and to address problems associated with elongated material cobbling. If a laying head pipe becomes so worn that it suffers a pipe wall rupture, the cobbling mishap can impact elongated material feed upstream of the laying head. From a wear resistance point of view it is desirable to form the laying head pipe inner wear surface from relatively hard low surface friction steel and further desirable to perform further surface hardening and heat treatment, but such wear treatment steps must be balanced with ease and cost of pipe fabrication.

Thus, in the past, those skilled in the art have deemed it necessary to compromise laying head pipe design and performance by employing larger bore laying head pipes and rolling at reduced speeds below the rated design speeds of the mills. The combination of larger than desired laying head pipe internal diameter and reduced rolling speeds have been implemented in order to schedule preventive maintenance pipe replacement during scheduled maintenance “downtime”. Conventional and current laying head pipes must be replaced after processing quantities of elongated material of approximately 3,000 tons or less with standard carbon steel pipe, depending on diameter, speed and product composition.

Those skilled in the art have made repeated attempts at increasing the useful life of laying head pipes for larger total processing tonnage, so that more elongated material can be processed before replacement. For example, as disclosed in U.S. Pat. Nos. 4,074,553 and 5,839,684, it has been proposed to line the laying head pipes with wear resistant insert rings that are inserted into an external laying head pipe casing. Adjoining rings within curved sections of the laying head pipe casing have discontinuity gaps that are not desirable for smooth advancement of elongated material that is being transported within the laying head pipe. U.S. Pat. No. 6,098,909 discloses a different approach where the laying head pipe is eliminated in favor of a guide path defined by a spiral groove in the outer surface of a conical insert enclosed by a conical outer casing, with the insert being rotatable within the outer casing to gradually shift the wear pattern on the inner surface of the outer casing. It is not believed that the spiral groove conical insert approach is readily compatible with all existing quill laying heads that presently incorporate laying head pipe structures.

Attempts have also been made at carburizing the interior laying head pipe surfaces in order to increase hardness and resistance to wear. But the carburizing process requires a drastic quenching from elevated processing temperatures, which can distort the pipe curvature. The carburized layer has also been found to be relatively brittle and to temper down at elevated temperatures resulting from exposure to the hot rolled products.

The owner of this patent application has also disclosed the application of a boronized layer to the laying head pipe wear surfaces by subjecting them to a thermochemical treatment in which boron atoms are diffused into the pipe interior to increase its hardness. See Patent Cooperation Treaty Application entitled “Boronized Laying Pipe”, filed in the United States Receiving Office on Sep. 2, 2011, Serial No. PCT/US2011/050314.

The owner of this patent application has also disclosed a laying head pipe having inner and outer friction-tight engaged concentric layers in which the inner layer advances axially relative to the outer layer during laying head operation due to centrifugal forces, differences in localized thermal expansion, and thermal cycling between the layers. Thus worn sections of the laying head pipe interior advance along the pipe interior so that a “fresh” unworn surface continually replenishes the worn section. See Patent Cooperation Treaty Application entitled “Regenerative Laying Pipe”, filed in the United States Receiving Office on Sep. 2, 2011, Ser. No. PCT/US2011/050283.

### SUMMARY

Accordingly, embodiments of the present invention include a rolling mill laying head elongated structure for retention and transport of elongated materials in a laying head, so that the elongated material can be selectively coiled. The laying head path structure may perform the functionality of a conventional laying head pipe. In aspects of the present invention, portions of the laying head path structure or the structure in its entirety has modular construction so that worn portions are selectively replaced. The replaceable segment modular component structure comprises a replacement element defining an elongated material transport path therein; and a coupling structure adapted for selectively coupling and aligning the replacement element material transport path with a corresponding mating transport path in an elongated path hollow structure of a coil-forming apparatus. Modular laying head path components can be constructed in any three dimensional compound curve shape that can replicate the smooth, continuous curve elongated material transport path of known laying pipes, or any other desired path. Such modular laying head component fabrication processes facilitate construction of asymmetrical structures that cannot be readily fabricated with bent symmetrical wall pipe, tubing or other conduits. The fabricated modular structures facilitate formation of zones within the component segment, such as including by way of example wear-resistant zones or friction reducing zones in the segment that are in direct contact with the elongated material.

Another exemplary embodiment includes a rolling mill coil-forming laying head system comprising a driven rotating quill and an elongated path hollow structure having an elongated material transport path therein. A modular replaceable segment is coupled to the elongated path hollow structure, having a replacement element defining at least a portion of the elongated material transport path therein; and a coupling structure adapted for selectively coupling and aligning the portion of the material transport path defined by replacement element with an adjoining portion of the material transport path defined by the elongated path hollow structure.

An additional exemplary embodiment of the present invention includes a method for installing a modular cartridge of a rolling mill coil-forming laying head system elongated path hollow structure that has an elongated material transport path therein and an access compartment adapted for receiving the cartridge, the cartridge having a replacement element defining a portion of the laying head system elongated path hollow structure elongated material transport path and a coupling structure adapted for selectively coupling the replacement element to the access compartment. The method comprises uncoupling the coupling structure and removing any cartridge already occupying the access compartment. A cartridge is then inserted into the access compartment. The cartridge is coupled to the access compartment with the coupling structure.

The features of aspects of the present invention may be applied jointly or severally in any combination or sub-combination by those skilled in the art. Further features of aspects and embodiments of the present invention, and the advantages offered thereby, are explained in greater detail hereinafter with reference to specific embodiments illustrated in the accompanying drawings, wherein like elements are indicated by like reference designators.

### BRIEF DESCRIPTION OF THE DRAWINGS

The teachings of the present invention can be readily understood by considering the following detailed description in conjunction with the accompanying drawings, in which:

FIG. 1 shows a side elevational view of a coil-forming apparatus laying head system, in accordance with an exemplary embodiment of the present invention;

FIG. 2 shows a top plan view of the laying head system of FIG. 1, in accordance with an exemplary embodiment of the present invention;

FIG. 3 shows a sectional elevational view of the laying head system of FIG. 1, including its end ring and tripper mechanism, in accordance with an exemplary embodiment of the present invention;

FIG. 4 shows an elevational view of the discharge end of the laying head system of FIG. 1, including its end ring and tripper mechanism, in accordance with an exemplary embodiment of the present invention;

FIG. 5 shows a known construction laying head transport path/pipe and typical exemplary wear zones experienced during laying head operation;

FIG. 6 shows a perspective view of a laying head elongated material transport path, in accordance with an exemplary embodiment of the present invention;

FIG. 7 shows an exploded view of the laying head path of FIG. 6;

FIG. 8 shows an axial cross-sectional view of the laying head path of FIG. 6;

FIG. 9 shows a schematic perspective view of a laying head path, having a modular replacement cartridge, in accordance with an exemplary embodiment of the present invention;

FIG. 10 shows an exploded view of the laying head path including the modular replacement cartridge of FIG. 9;

FIG. 11 shows a schematic perspective view of a non-pipe shaped laying head path elongated hollow member with a plurality of modular replacement cartridges, in accordance with another exemplary embodiment of the present invention.

FIG. 12 shows a partial cut away axial cross-sectional view of a laying head path modular replacement cartridge, in accordance with another exemplary embodiment of the present invention; and

FIG. 13 shows a radial cross-sectional view of the laying head path modular replacement cartridge of FIG. 12, taken along 10-10 thereof.

To facilitate understanding, identical reference numerals have been used, where possible, to designate identical elements that are common to the figures.

### DETAILED DESCRIPTION

After considering the following description, those skilled in the art will realize that the teachings of the present invention can be utilized in rolling mill coil-forming apparatus laying heads and more particularly to laying head elongated transport path pipes or other equivalent elongated structures for laying heads. Aspects of the present invention facilitate longer laying head path service life so that more tons of elongated material can be processed by the laying head before preventative maintenance replacement. For example, it is possible to increase the laying head elongated material processing speed so that more tons of elongated material can be processed in a production shift without undue risk of laying head path/pipe failure. A portion or the entire elongated structure is formed from modular, selectively replaceable components. The fabricated modular structures facilitate replacement of zones within the elongated path that are subject to greater wear than the rest of the structure. The fabricated modular structures also facilitate formation and reconfiguration of zones within the component, such as including by way of example wear-resistant zones, material transport guide structures and friction reducing zones.

Laying Head System Overview

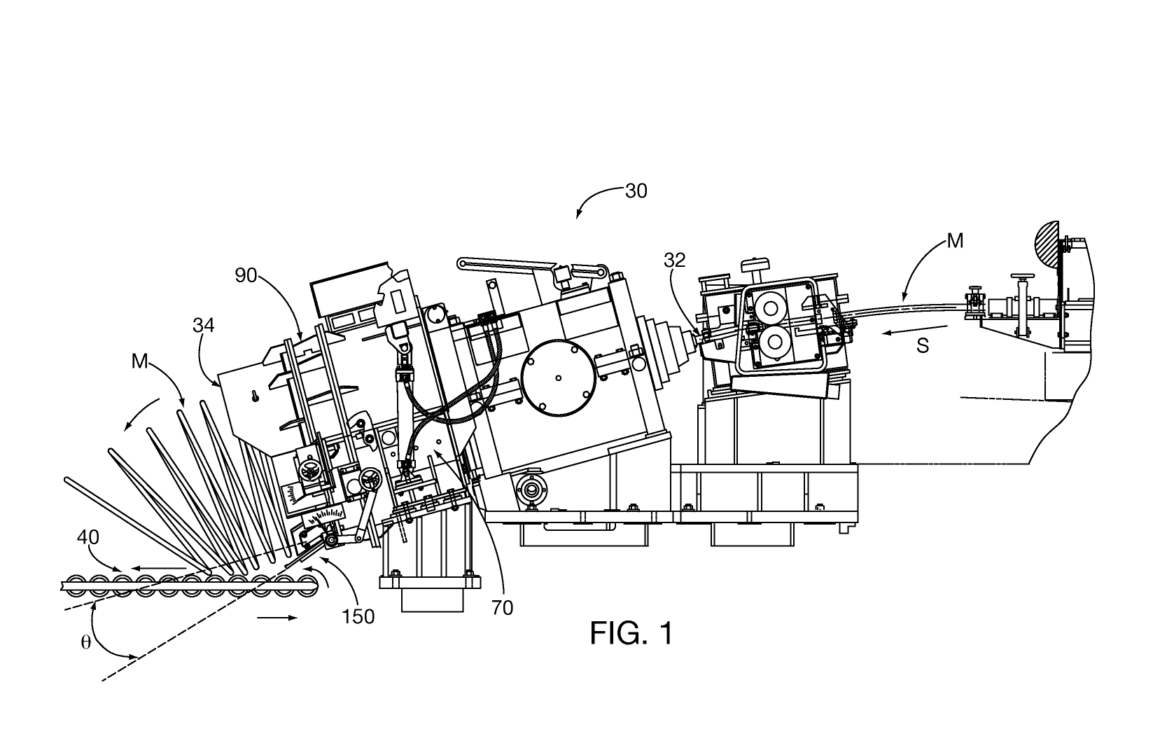

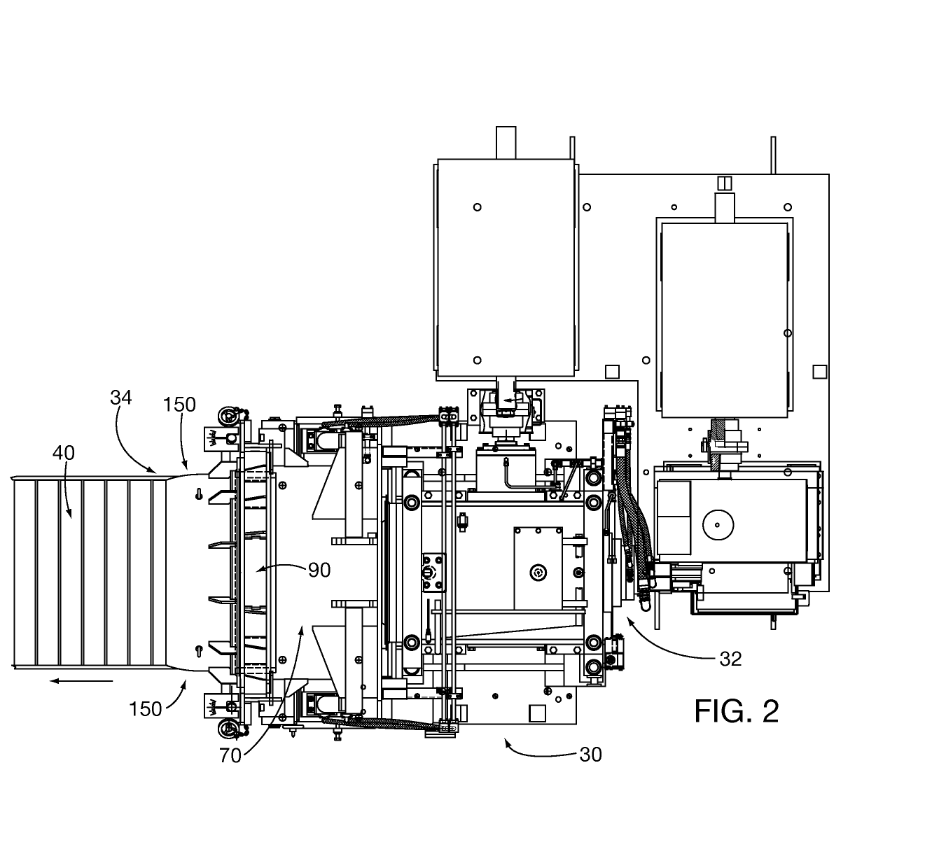

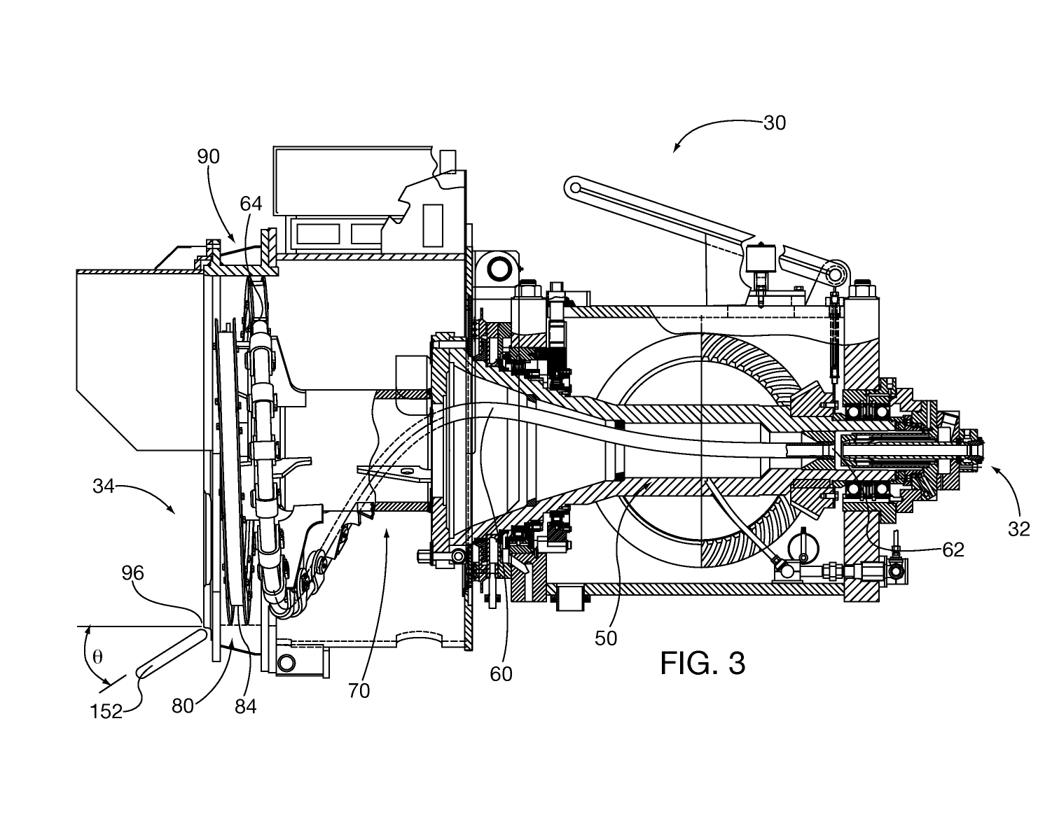

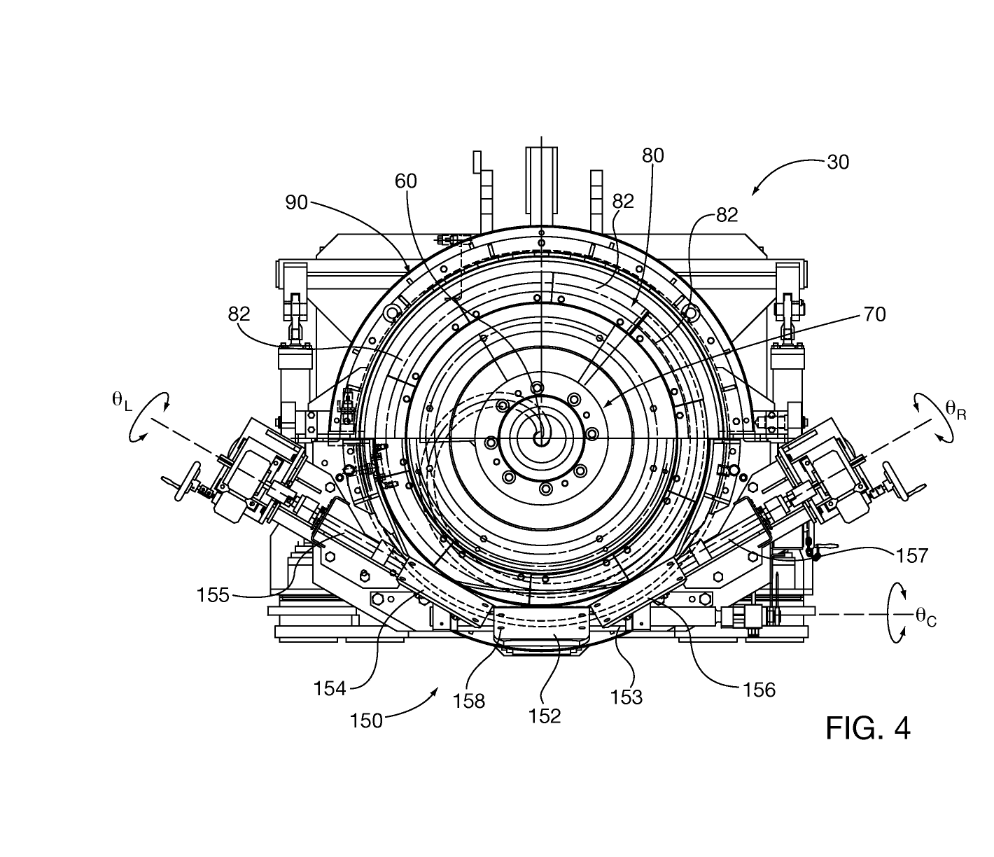

Referring generally to FIGS. 1-4, the coil-forming apparatus laying head system 30 coils rolled elongated material M, such as for example hot rolled steel. Elongated material M that is advancing at speed S, which may be as high as or greater than approximately 500 feet/second (150 m/sec), is received in the laying head system 30 intake end 32 and discharged in a series of continuous coil loops at the discharge end 34, whereupon the coils are deposited on a conveyor 40.

The laying head system 30 comprises a rotatable quill 50, a path 60 and a pipe path support 70. The path 60 defines a hollow elongated cavity to enable transport of the material M. Aspects of the present invention allow the path to comprise a laying head pipe; indeed, the path 60 may occasionally be referred to as a laying head pipe herein.

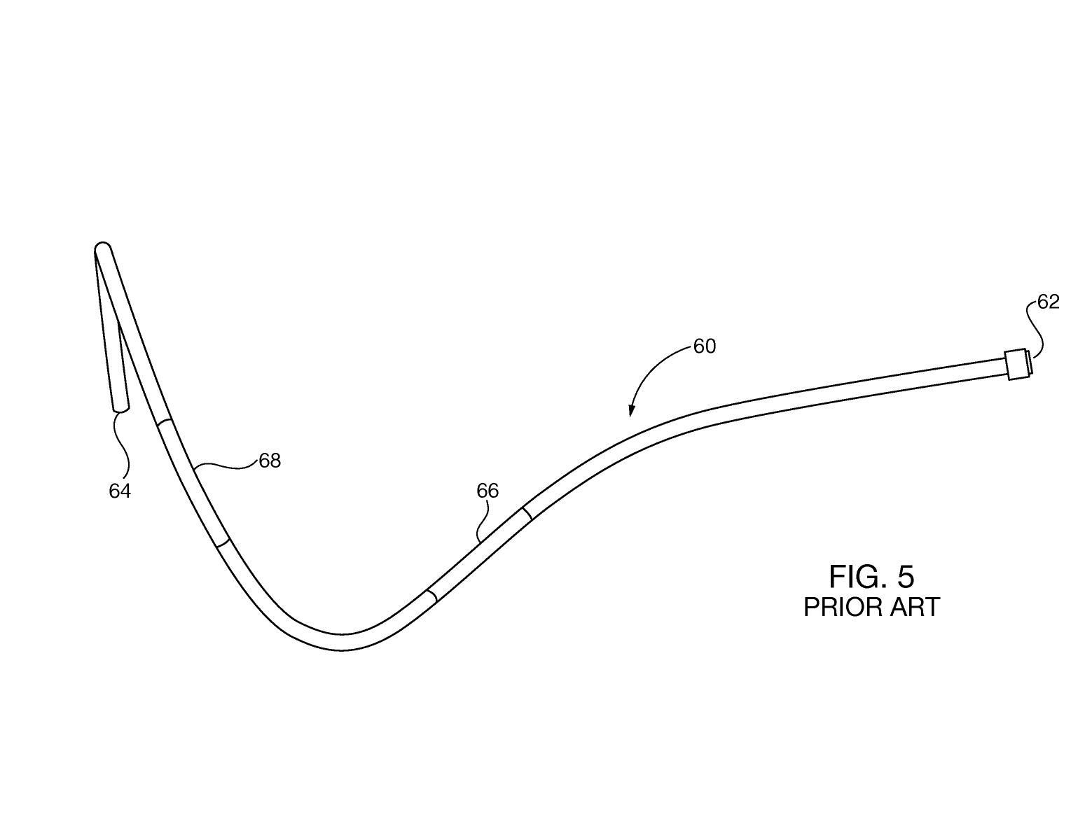

The quill 50 can have a generally horn shape that is adapted to rotate about an axis. The path 60 has a generally helical axial profile of increasing radius, with a first end 62 that that is aligned with the rotational axis of quill 50 and receives elongated material M. The path 60 has a second end that is spaced radially outwardly from and generally tangential to the quill 50 rotational axis and thus discharges the elongated material generally tangentially to the periphery of the rotating quill. The path 60 is coupled to a pipe support 70 that is in turn coupled coaxially to the quill 50, so that all three components rotate synchronously about the quill rotational axis. The quill 50 rotational speed can be selected based upon, among other factors, the elongated material M structural dimensions and material properties, advancement speed S, desired coil diameter and number of tons of elongated material that can be processed by the laying head pipe without undue risk of excessive wear. FIG. 5 shows conventional laying head path/pipe 60 wear zones 66, 68 in which the pipe interior is subjected to relatively higher wear rates than other portions of the pipe. Aspects of the present invention address the higher wear rates by locally hardening the zones 66, 68 and other portions or all other desired zones. In an embodiment, the entire or equivalent elongated structure can be hardened by application of aspects of the present invention.

As illustrated, as elongated material M is discharged from the second end 64, it is directed into a ring guide 80 having guide rim segments 82 into which are formed a guide trough channel 84 having a helical pitch profile, such as that described in commonly owned U.S. Pat. No. 6,769,641. As the elongated material M is advanced through the ring guide 80 it is continued to be conformed into a continuous loop helix.

As described in the '641 patent, the segmented ring guide enables relatively easy reconfiguration of the ring guide helical diameter to accommodate different elongated materials by changing the rim segments 82 without disassembling and replacing the entire ring guide 80.

As previously noted, the elongated material M is configured into a continuous looped coil as it rides within the ring guide 80 helical trough channel 84. Ring guide 80 is coupled to the pipe support 70 and rotates coaxially with the quill 50. The helical trough 84 advancement rotational speed is harmonized with the elongated material M advancement speed S, so there is little relative linear motion speed between the two abutting objects and less rubbing wear of the trough 84 surfaces that contact the coiling material.

Stationary end ring 90 has an inner diameter that is coaxial with the quill 50 rotational axis and circumscribes the laying path/pipe 60 second end 62 as well as the ring guide 80. The end ring 90 counteracts centrifugal force imparted on the elongated material M as it is discharged from the laying head pipe 60 second end 62 and advances along the ring guide 80 helical trough channel 84 by radially restraining the material within the end ring inner diameter guide surface. High relative speed between the advancing elongated material M and the stationary end ring 90 causes rubbing wear on the end ring inner diameter guide surface.

Referring to FIG. 1, elongated material M that is discharged from the coil-forming apparatus laying head system 30 falls by gravity in continuous loops on roller conveyor 40, aided by the downwardly angled quill rotational axis at the system discharge end 34. Tripper mechanism 150 pivots about an axis abutting the distal axial side of the end ring 90 guide surface. That pivotal axis is generally tangential to the end ring 90 inner diameter guide surface about a pivotal range of motion θ. As is known, coiled material M coiling characteristics and placement on the conveyor 40 can be controlled by varying the pivotal angle θ.

Laying Head Path Structure Fabrication

Embodiments of the present invention include a rolling mill laying head path structure, for retention and transport of elongated materials in a laying head, so that the elongated material can be selectively coiled. A portion of the path structure, or the structure in its entirety, is constructed of modular replaceable sections or cartridges. In this way, only worn sections are replaced as necessary during laying head service scheduled maintenance without replacing the entire laying head path structure.

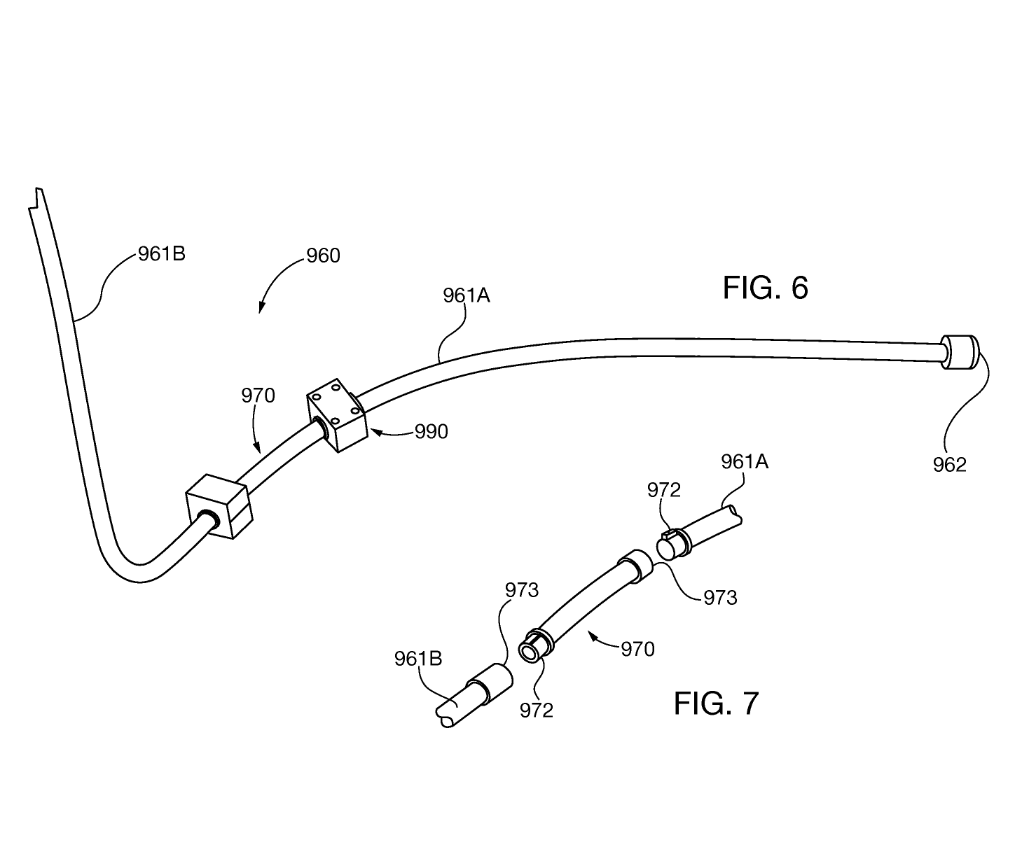

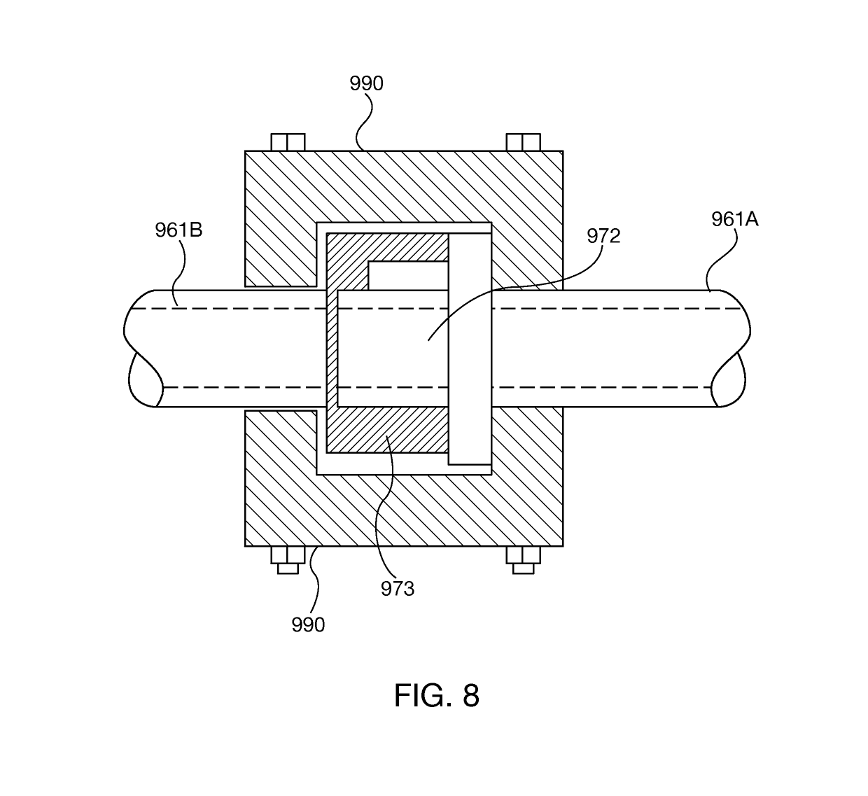

FIGS. 6-8 show a modular construction laying head path 960 that has a generally cylindrical outer profile conforming to known laying head pipes, for direct substitution in a known laying head such as the one shown in FIGS. 1-5. Laying head pipe 960 is a composite structure fabricated from modular subcomponents. The laying path 960 has a first steel pipe section 961A with an upstream intake end 962 and a second steel pipe section 961B that discharges elongated material from the laying head in coiled loops. The insert 970 is asymmetrical with a keyed and flanged male end portion 972 that mates with a complimentary flanged female portion 973 that is formed in the second steel pipe section 961B. The insert 970 also has a female portion 973 at its other axial end that mates with a keyed male end portion 972 formed on the first steel pipe section 961A. A circumferential clamp 990 circumscribes flanges of the respective axially mating male end portion 972 and female end portion 973. Other types of known mating end portions may be substituted for the ones shown in FIGS. 6-8.

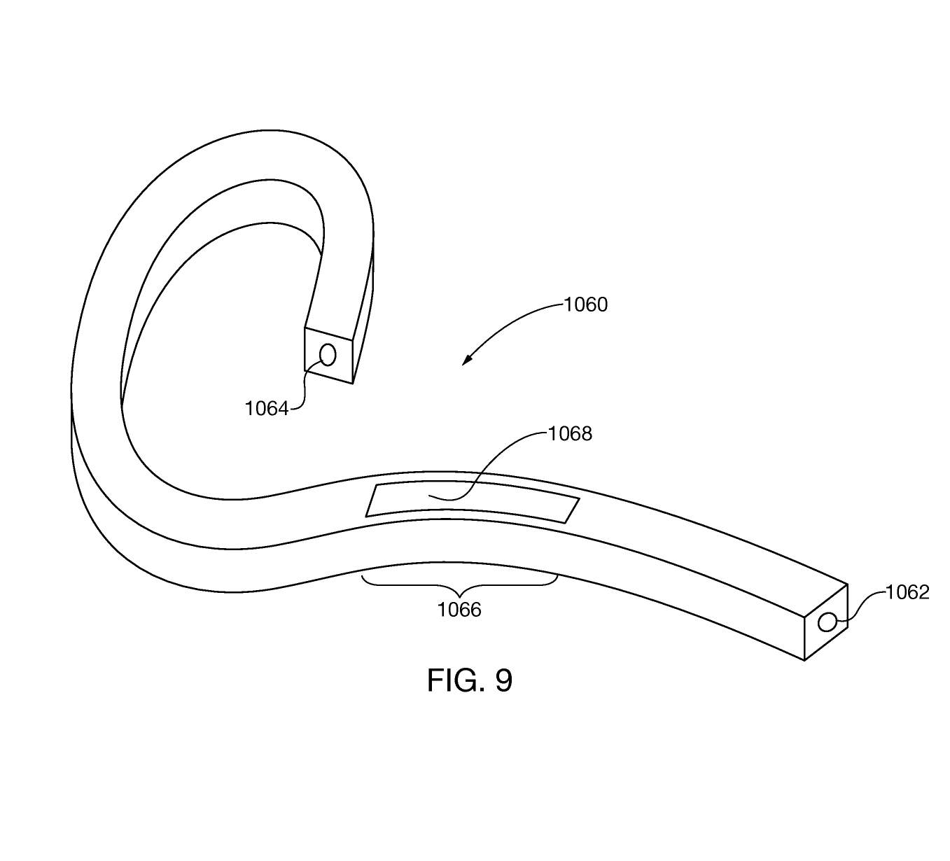

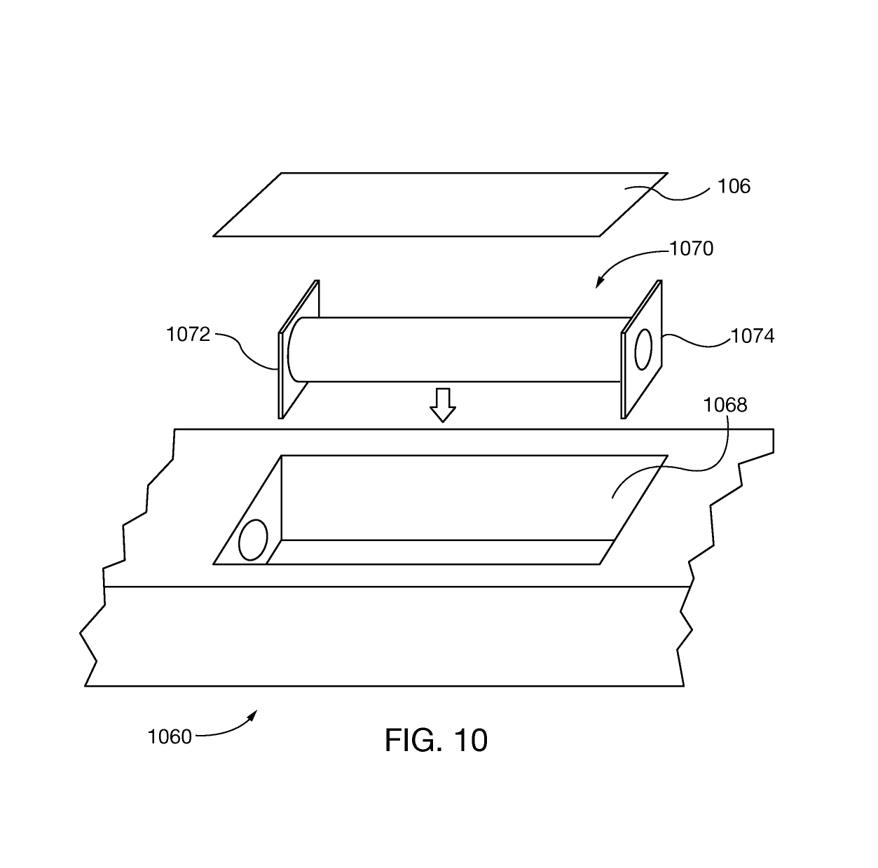

FIGS. 9 and 10 show an alternative embodiment laying head path elongated hollow structure 1060 for coiling elongated material. The laying head elongated structure 1060 does not have a traditional known pipe-like profile but establishes a generally helical shaped elongated material internal transport path from its intake end 1062 to its discharge end 1064. The elongated structure 1060 has a replaceable modular cartridge section 1066 that includes an access compartment 1068 for insertion of a modular replacement cartridge 1070. As shown in FIG. 10 the replacement cartridge 1070 has flanged ends 1072, 1074 for engagement with respective ends of the access compartment 1068, and is sealed with cover 106.

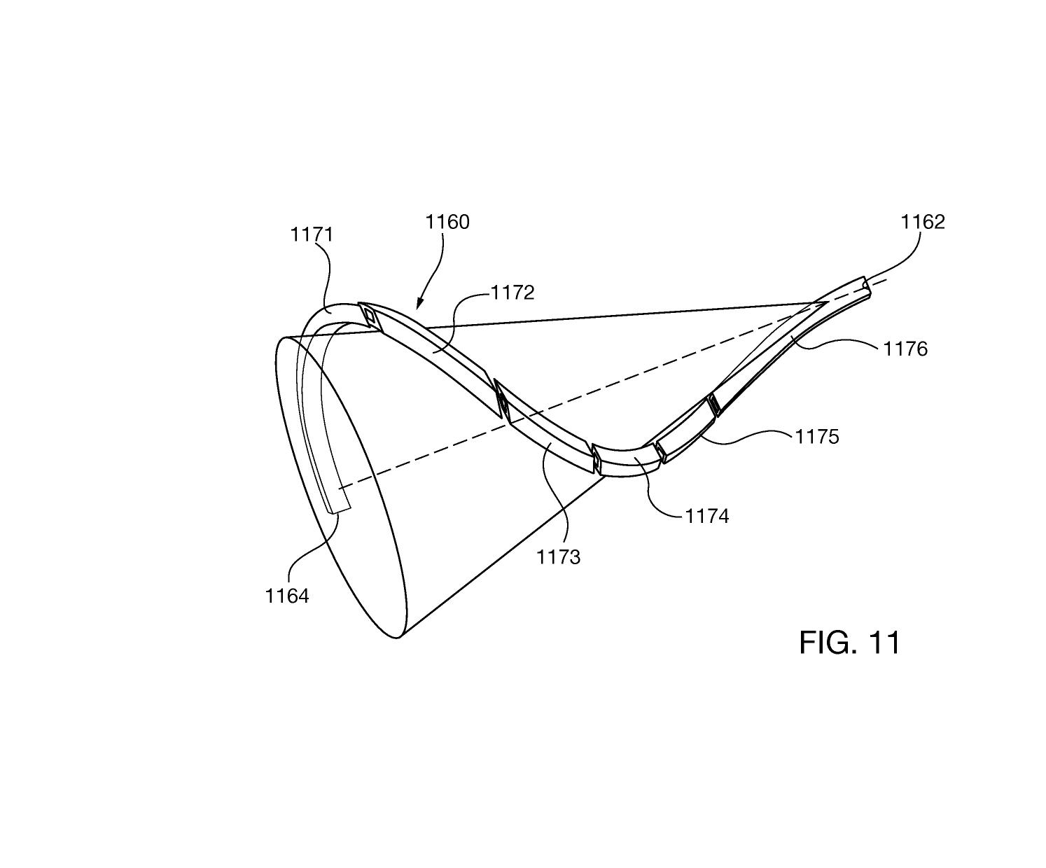

FIG. 11 shows another alternative embodiment of a non-pipe-shaped laying head hollow cavity elongated structure 1160 that has an elongated material transport path with an intake end 1162 and discharge end 1164. The elongated structure 1160 is constructed with a plurality of axially adjoining segments 1171-1176, any one or more of which is selectively replaceable.

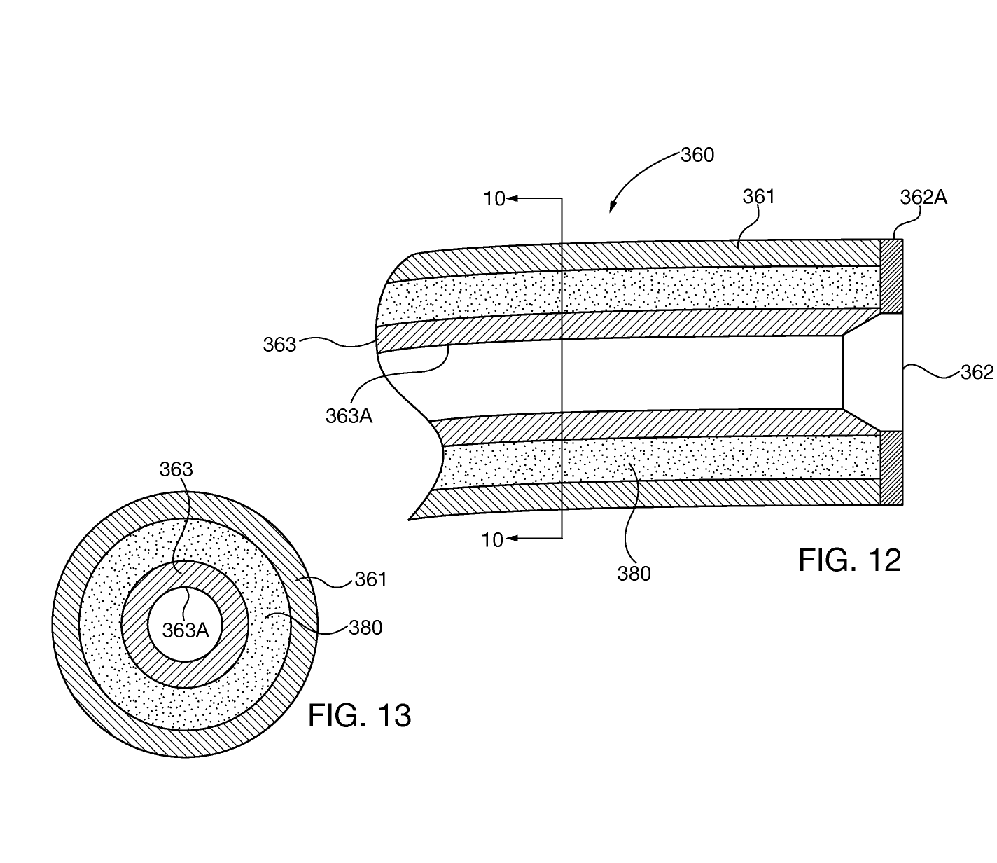

FIGS. 12 and 13 show another embodiment of the laying head path modular section or replacement cartridge 360 of the present invention that has a first intake end 362 with an annular retaining collar 362A. The laying head path modular section 360 is a composite structure fabricated from nested subcomponents including an outer steel pipe or tube 361 and an inner pipe or tube 363 formed from tungsten carbide tubing or tungsten carbide sintered to form a generally tubular hollow structure. The inner tube 363 has a continuous inner surface 363A for contact with elongated material that is transported through the laying head path. The inner surface 363A may be surface coated or treated to harden the surface or provide a friction reducing surface. An optional insulating high temperature grout layer 380 may be interposed between the outer pipe 361 and the inner pipe 363. While not shown in FIGS. 12 and 13 the modular section 360 may include coupling structure for coupling to adjoining segments or sections in a laying head path elongated structure, for example as shown in other embodiments herein.

The fabricated modular elongated laying path structures facilitate formation of zones within the components, such as including by way of example wear-resistant zones or friction reducing zones. Those zones can be formed during the modular cartridge fabrication process, such as by inserting pipes constructed of different material into each other or by abutting sections of different materials next to each other in a given layer. Portions of the modular components or entire components may be fabricated from various ferrous or non-ferrous materials, including ceramics, preferred examples comprising ferrous metals, nickel based alloys, cobalt based alloys and titanium based alloys, as well as deposited nano particle coatings of any of them. Different coating materials may be deposited in abutting relationship to form the laying path inner surface within a modular component. More specifically a component outer layer or pipe, if any, comprises any desired material or metal (steel often being a cost effective choice) or non-metallic structures, such as filament reinforced carbon fiber. The inner surface of a filament reinforced carbon fiber or other outer elongated path modular component may include an inner layer formed from a nano particle layer of non-ferrous material, such as stainless steel or tungsten carbide, deposited thereon, including abutting deposited layers of materials. The deposited nano layer(s) function(s) as the equivalent of a separate inner pathway structure. The modular component inner layer path forming structure may comprise ferrous or non-ferrous materials, including ceramic, nano particle material coatings, steel, or non-ferrous alloys such as stainless steel, tungsten carbide or so-called super alloys, such as for example Inconel®, Waspaloy® or Hastelloy®. Other non-ferrous metals may be substituted within modular components, comprising by way of example stainless steel, tungsten carbide, and so-called super alloys, such as for example Inconel®, Waspaloy® or Hastelloy®, ceramics or nano particle layers of the above. The inner surface that is in contact with the elongated material may be treated or coated (including nano particle coatings) to increase surface hardness, reduce friction or decrease thermal ablation. Alternatively one or more of the separate modules forming the entire elongated structure path/pipe can be constructed from a single homogeneous one of such non-ferrous materials of any desired dimensional circumferential profile inner or outer diameter and thickness. That homogeneous non-ferrous module can be nested inside or circumscribe one or more path layers to form a multilayer modular component of two or more layers. The multilayer modular component is then formed into any desired three dimensional profiles to form a laying head path elongated structure.

Although various embodiments, which incorporate the teachings of the present invention, have been shown and described in detail herein, those skilled in the art can readily devise many other varied embodiments that still incorporate these teachings.

What is claimed is:

1. A modular replaceable segment apparatus for a rolling mill coil-forming apparatus elongated path hollow structure, comprising:
a replacement element defining an elongated material transport path therein; and
a coupling structure adapted for selectively coupling and aligning the replacement element material transport path with a corresponding mating transport path in an elongated path hollow structure of a coil-forming apparatus.

2. The apparatus of claim 1, having an asymmetrical profile.

3. The apparatus of claim 2, the asymmetrical profile selected from the group consisting of cross section, twist about elongate axis, and replacement element elongated material transport path inner surface.

4. The apparatus of claim 1, the replacement element having a zone selected from the group consisting of wear resistant zone, projecting material standoff, material transport guide structures and friction reducing zone.

5. The apparatus of claim 1, further comprising a plurality of modular replaceable segments adapted for assembly as an elongated path hollow structure for a coil-forming apparatus.

6. The apparatus of claim 1, the coupling structure further comprising an outer housing retaining the replacement element therein.

7. The apparatus of claim 1, the coupling structure further comprising interlocking elements coupled to the replacement element, adapted for mating engagement with an elongated path hollow structure in a coil-forming apparatus.

8. The apparatus of claim 7, the interlocking elements selected from group consisting of splined ends, keyed ends, flanged collars coupled by clamps and flanged collars coupled by fasteners.

9. The apparatus of claim 1, the replacement element transport path defining an inner surface comprising non-ferrous materials selected from group consisting of nickel based alloys, cobalt based alloys and titanium based alloys, stainless steel, tungsten carbide, ceramics, superalloys and nano layers of said non-ferrous materials deposited on the inner surface.

10. The apparatus of claim 1, comprising a tubular replacement element.

11. The apparatus of claim 1, the coupling structure adapted for selectively coupling the replacement element within an access compartment of the elongated path hollow structure.

12. A rolling mill coil-forming laying head system comprising:
a driven rotating quill;
an elongated path hollow structure having an elongated material transport path therein; and
a modular replaceable segment coupled to the elongated path hollow structure, having:
a replacement element defining at least a portion of the elongated material transport path therein; and
a coupling structure adapted for selectively coupling and aligning the portion of the material transport path defined by replacement element with an adjoining portion of the material transport path defined by the elongated path hollow structure.

13. The system of claim 12, comprising the replacement element having an asymmetrical profile selected from the group consisting of cross section, twist about elongate axis, and replacement element elongated material transport path inner surface.

14. The system of claim 12, comprising the replacement element having a zone selected from the group consisting of wear resistant zone, projecting material standoff, material transport guide structures and friction reducing zone.

15. The system of claim 12, the elongated path hollow structure further comprising a plurality of adjoining coupled modular replaceable segments.

16. The system of claim 12, the coupling structure further comprising an outer housing retaining the replaceable element portion therein.

17. The system of claim 12, the coupling structure further comprising interlocking elements coupled to the replacement element adapted for mating engagement with the elongated path hollow structure.

18. The system of claim 12, the replacement element transport path defining an inner surface comprising non-ferrous materials selected from group consisting of nickel based alloys, cobalt based alloys and titanium based alloys, stainless steel, tungsten carbide, ceramics, superalloys and nano layers of said non-ferrous materials deposited on the inner surface.

19. The system of claim 12, further comprising:
the elongated path hollow structure having an access compartment; and
the modular replaceable segment adapted for selective insertion into the access compartment and retention therein by the coupling structure.

20. A method for installing a modular cartridge of a rolling mill coil-forming laying head system elongated path hollow structure that has an elongated material transport path therein and an access compartment adapted for receiving the cartridge, the cartridge having a replacement element defining a portion of the laying head system elongated path hollow structure elongated material transport path and a coupling structure adapted for selectively coupling the replacement element to the access compartment, the method comprising:
uncoupling the coupling structure and removing any cartridge already occupying the access compartment;
inserting a cartridge into the access compartment; and
coupling the cartridge to the access compartment with the coupling structure.
